(19) United States
(12) Patent Application Publication
(10) Pub. No.: US 2003/0057580 A1
(43) Pub. Date: Mar. 27, 2003

(54) Balloon arrangement

(76) Inventor: Gilbert Salomon Rosenberg, Sao Paulo (BR)

Correspondence Address: HAMILTON, BROOK, SMITH & REYNOLDS, P.C., 530 VIRGINIA ROAD, P.O. BOX 9133, CONCORD, MA, 01742-9133, US

(21) Appl. No.: 10/201,578

(22) Filed: Jul. 22, 2002

(30) Foreign Application Priority Data
Jul. 23, 2001 (BR) MU 8101269-6

(51) Int. Cl. B29B 9/00

(52) U.S. Cl. 264/10

(57) ABSTRACT

An arrangement introduced into a balloon is capable to be applied in any inflated balloon having a traditional nozzle or mouthpiece, where the upper end of a flexible rod is fastened.

### RELATED APPLICATION

This application claims priority under 35 U.S.C. §119 to Brasillian Application No. MU 8101269-6, filed Jul. 23, 2001. The entire teachings of the above application are incorporated herein by reference.

### BACKGROUND OF THE INVENTION

There is currently a large variety of balloons, some of them manufactured of plastic films and others made of elastic material, such as rubber. Besides the different shapes, however, all of them are generally manufactured with a nozzle or a small longish mouthpiece, which has two purposes. The first is to inflate the balloon with air or gas, while the second purpose is to configure a point for fastening a string, whose other end, after a loop has been formed, is generally used to hold the balloon, especially when the balloon is inflated with gas lighter than air, since the use of the string is essential in this case.

The common balloons may offer all the features for being used as a toy, but in many cases the string is not always considered a comfortable way to hold the balloon, not only due to the fact that the free end of the string is often tied to a child's arm, but also regarding the fact that the string does not allow a major control of floating movements of the balloon. In other words, when holding the balloon by the string, it can swing from one side to the other and in closed environments these movements let the balloon beat against objects, which may even cause little accidents, and damage to the balloon On the other hand, if the string escapes from the child's arm, the balloon may inevitably be lost.

### SUMMARY OF THE INVENTION

More particularly, the present device refers to technical and functional enhancements especially developed and introduced to traditional balloons, which are manufactured of plastic films or other kinds of material, such as rubber, and generally inflated with air or gas, the gas being lighter than air.

An arrangement is introduced into a balloon that is capable of being applied in a balloon inflated with a gas lighter than air, manufactured from plastic film or elastic materials, and having a traditional nozzle or mouthpiece. A rod, which is substantially long and flexible, has one end fastened to the mouthpiece, while the other end is completely free.

An alternative embodiment is disclosed so that the balloon can be held with more safety and furthermore provide a means in order to avoid that the balloon, inflated with gas lighter than air, gets lost when it is released or escapes from the hand.

In order to achieve such purposes, the present invention includes the use of a substantially long, solid or tubular rod, whose upper end is fastened in a proper way to the mouthpiece of the balloon, while the opposite end provides means to hold the object in a safe manner.

Another purpose of the invention is furthermore the configuration of a flexible rod having an appropriate weight in order to neutralize the floating of the balloon, i.e., if the rod escapes from the hand or is released, the balloon moves upwards just the course which is sufficient to keep the rod in an upright position and the balloon does not rise more than that small distance, thus making the object ideal for very little children.

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1 shows a view in a raised position of a balloon configured according to the present invention.

FIG. 2 shows an exploded view, illustrating a preferred fastening of the flexible rod.

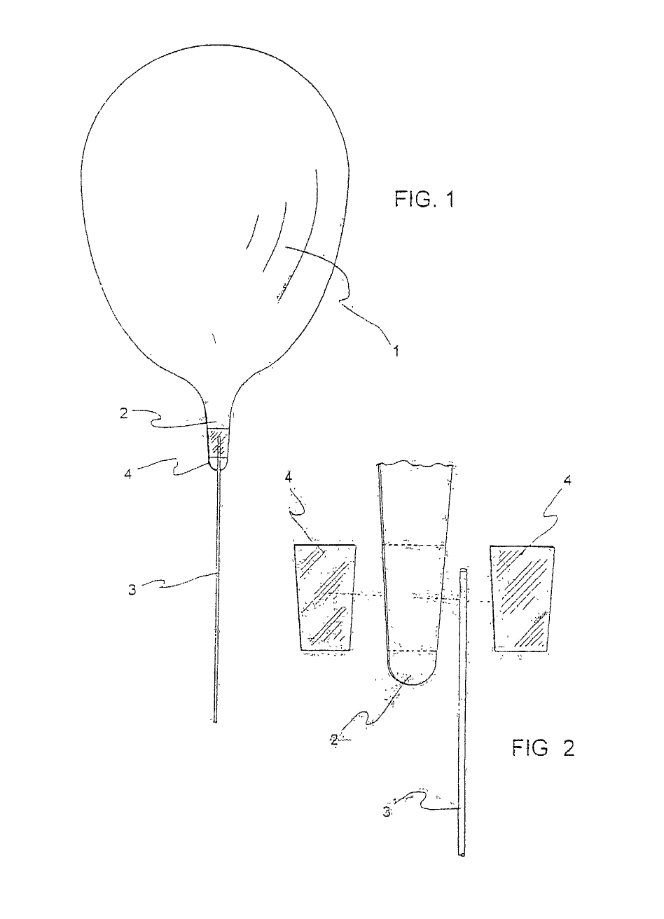

### DETAILED DESCRIPTION OF THE INVENTION

A description of preferred embodiments of the invention follows.

According to these illustrations and in its details, the present device can be used in any balloon inflated with gas lighter or less dense than air (1), such as helium, provided with a traditional nozzle or mouthpiece (2), where the device presents as a novelty the fact that a rod (3), substantially long and flexible, preferably made of plastic material, has one end fastened to the mouthpiece (2), while its other end is completely free.

The rod (3) presents a mass or weight, which is appropriate to neutralize or maintain the floating property of the balloon in balance (1).

The rod (3) preferably consists of a plastic tube with a reduced diameter.

In an alternative constructive configuration, the rod (3) can be manufactured of solid material, having a cross section of any shape. In a preferred configuration, the upper end of the rod (3) is fastened to the mouthpiece (2) by means of a thermowelding process. In another configuration, the upper end of the rod (3) is fixed between adhesive or thermowelded elements (4).

As one can easily see after the explanation and illustration presented, the object at issue, since besides being capable for industrial application, provides a new form or arrangement which results in a functional enhancement of its use. The rod (3), besides representing a different way to hold the balloon (1), avoids that the balloon may be lost, because if the rod (3) should escape from the hand, the floating movement of the balloon occurs until the rod is in an upright position, where its lower end rests on the ground; moreover, the rod (3) allows a better control of floating movements of the balloon (1) when the balloon is carried in closed environments.

While this invention has been particularly shown and described with references to preferred embodiments thereof, it will be understood by those skilled in the art that various changes in form and details may be made therein without departing from the scope of the invention encompassed by the appended claims.

What is claimed is:

1. An arrangement introduced into a balloon, capable to be applied in a balloon inflated with a gas lighter than air, manufactured from plastic film or elastic materials, having a traditional nozzle or mouthpiece, characterized by a rod, which is substantially long and flexible, having one end fastened to said mouthpiece, while the other end is completely free.

2. An arrangement introduced into a balloon, according to claim 1, wherein the rod includes a mass or weight appropriate to neutralize or keep in balance the floating characteristic of the balloon.

3. An arrangement introduced into a balloon according to claim 1, wherein the rod includes a plastic tube with a reduced diameter and being substantially flexible.

4. An arrangement introduced into a balloon, according to claim 1, wherein the rod is made of solid material.

5. An arrangement introduced into a balloon, according to claim 1, wherein the rod is made of solid material and having a cross section of any shape.

6. An arrangement introduced into a balloon, according to claim 1, wherein an the upper end of the rod is fastened to the mouthpiece by thermowelding.

7. An arrangement introduced into a balloon, according to claim 1, wherein an end of the rod is fixed between adhesive or thermowelded elements.

8. An arrangement introduced into a balloon according to claim 1, wherein the rod is formed from a plastic material.
